(19) United States
(12) Patent Application Publication
(10) Pub. No.: US 2016/0257191 A1
(43) Pub. Date: Sep. 8, 2016

(54) Vehicular Drive Assembly

(71) Applicant: George Dickens, JR., Tybee Island, GA (US)

(72) Inventor: George Dickens, JR., Tybee Island, GA (US)

(21) Appl. No.: 14/640,190

(22) Filed: Mar. 6, 2015

(51) Int. Cl. B60K 6/52

(52) U.S. Cl. CPC B60K 6/52; Y10S 903/903

(57) ABSTRACT

A vehicular drive assembly for providing independent rotational torque to each wheel of a vehicle includes a vehicle that has a frame and a plurality of wheels rotatably coupled to the frame. A plurality of drive arrays is attached to the vehicle and each of the wheels has one of the drive arrays mechanically attached thereto. Each of the drive arrays applies a rotational torque to an associated one of the wheels thereby facilitating each of the wheels to have an independent power source.

### BACKGROUND OF THE DISCLOSURE

### Field of the Disclosure

The disclosure relates to drive devices and more particularly pertains to a new drive device for providing independent rotational torque to each wheel of a vehicle.

### SUMMARY OF THE DISCLOSURE

An embodiment of the disclosure meets the needs presented above by generally comprising a vehicle that has a frame and a plurality of wheels rotatably coupled to the frame. A plurality of drive arrays is attached to the vehicle and each of the wheels has one of the drive arrays mechanically attached thereto. Each of the drive arrays applies a rotational torque to an associated one of the wheels thereby facilitating each of the wheels to have an independent power source.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a vehicular drive assembly according to an embodiment of the disclosure.

FIG. 2 is a bottom view of an embodiment of the disclosure.

FIG. 3 is a schematic view of an embodiment of the disclosure.

### DESCRIPTION OF THE PREFERRED EMBODIMENT

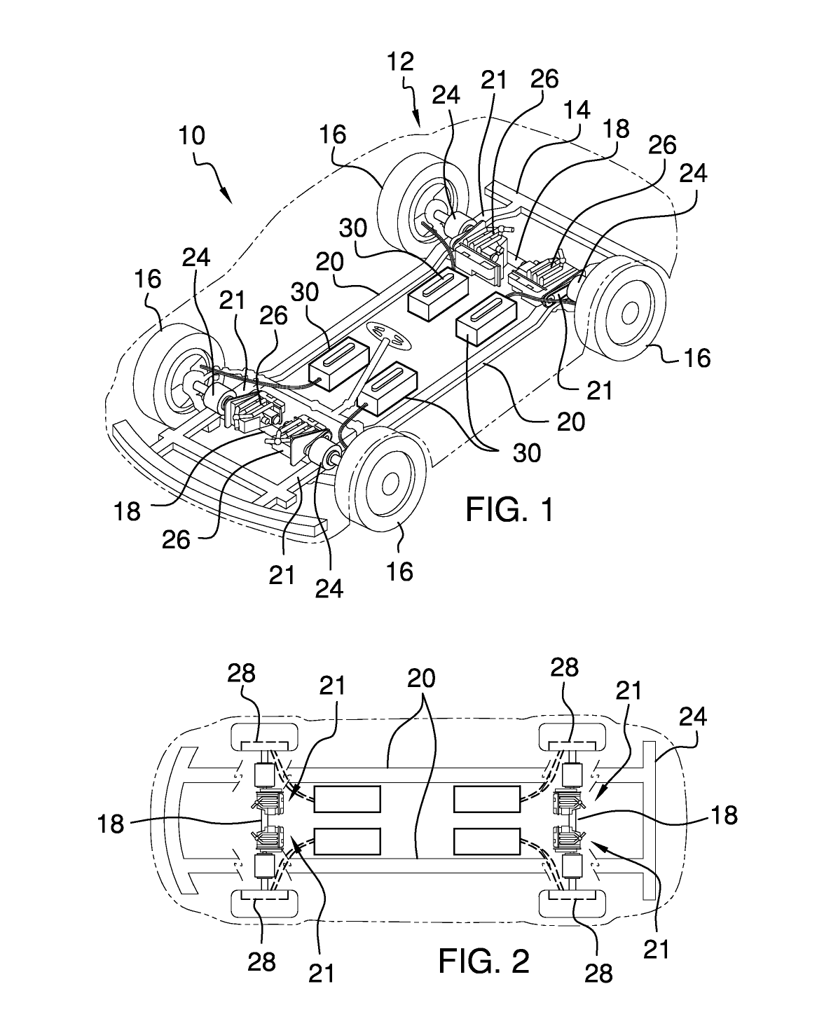

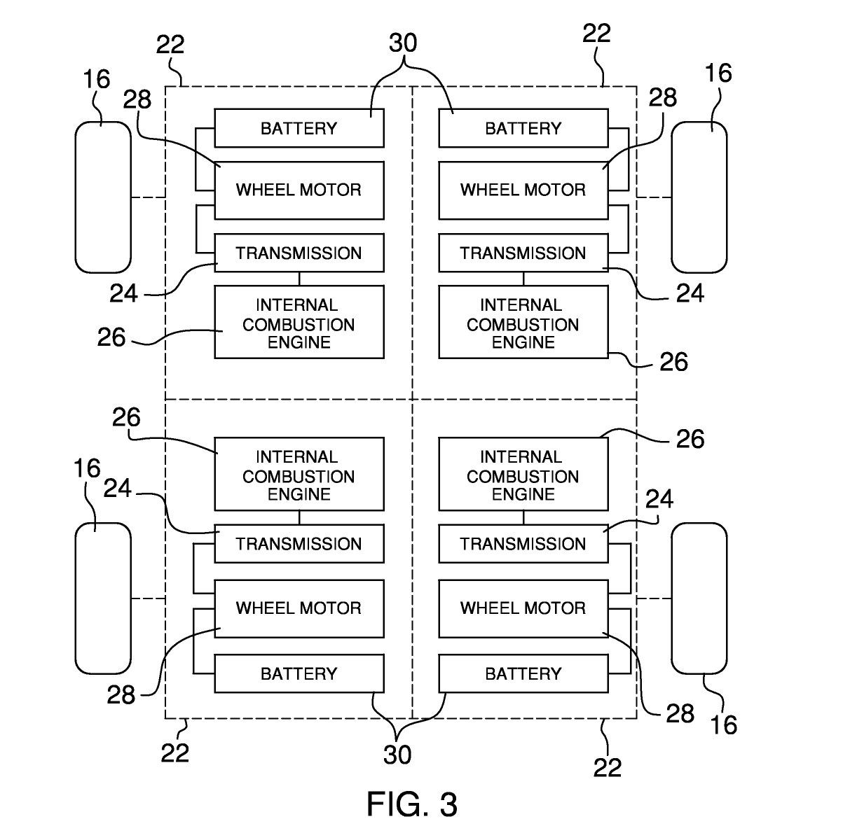

With reference now to the drawings, and in particular to FIGS. 1 through 3 thereof, a new drive device embodying the principles and concepts of an embodiment of the disclosure and generally designated by the reference numeral 10 will be described.

As best illustrated in FIGS. 1 through 3, the vehicular drive assembly 10 generally comprises a vehicle 12 that has a frame 14 and a plurality of wheels 16 rotatably coupled to the frame 14. The vehicle 12 may be a passenger vehicle or the like and the wheels 16 may be arranged in any particular arrangement on the frame 14. The frame 14 may comprise a pair of lateral members 18 each coupled to and extending between a pair of longitudinal members 20 and each of the wheels 16 may be positioned at one of four intersections 21 of the lateral members 18 and the longitudinal members 20.

A plurality of drive arrays 22 are provided and are attached to the vehicle 12. Each of the drive arrays 22 may be positioned at one of the four intersections 21 of the lateral members 18 and the longitudinal members 20 and each of the wheels 16 has one of the drive arrays 22 mechanically attached thereto. Each of the drive arrays 22 applies a rotational torque to an associated one of the wheels 16 thereby facilitating each of the wheels 16 to have an independent power source.

Each of the drive arrays 22 comprises a transmission 24 that is attached to the frame 14. Each of the wheels 16 has the transmission 24 of one of the drive arrays 22 mechanically coupled thereto such that the transmission 24 of each of the drive arrays 22 discretely rotates the associated one of the wheels 16. The transmission 24 may be an automobile transmission or the like.

Each of the drive arrays 22 further includes an internal combustion engine 26 that is attached to the frame 14. The internal combustion engine 26 is mechanically coupled to the transmission 24 and the internal combustion engine 26 drives the transmission 24 when the internal combustion engine 26 is actuated. The internal combustion engine 26 may comprise a three cylinder, two stroke internal combustion engine or the like.

Continuing, each of the drive arrays 22 includes a motor 28 that is attached to the vehicle 12. Each of the wheels 16 has the motor 28 of one of the drive arrays 22 positioned therein such that the motor 28 of each of the drive arrays 22 discretely rotates the associated one of the wheels 16. The motor 28 is mechanically discrete from the transmission 24. The motor 28 may comprise an in-wheel electrical motor produced by Protean Electric Inc, 100 West big Beaver Road, Suite 200, Troy Mich. 48085. Each of the drive arrays 22 additionally includes a power supply 30 that is attached to the vehicle 12. The power supply 30 is electrically coupled to the motor 28 and the power supply 30 comprises at least one battery 32.

In use, the vehicle 12 is utilized in the convention of passenger vehicles. The plurality of drive arrays 22 provides multiple layers of redundancy of power for the vehicle 12. In the event of a mechanical failure of the internal combustion engine 26 of one of the drive arrays 22, the vehicle 12 is still capable of being driven using the power produced by the remaining, functional internal combustion engines 26. Likewise, in the event of a mechanical failure of the motor 28 or power supply 30 of one of the drive arrays 22, the vehicle 12 is still capable of being driven using the power produced by the remaining, functional motors 28 and power supplies 30. The motor 28 may be utilized independently of the internal combustion engine 26 or the motor 28 may be utilized in tandem with the internal combustion engine 26.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicular drive assembly configured to provide multiple levels of redundancy, said assembly comprising:
a vehicle having a frame and a plurality of wheels rotatably coupled to said frame; and
a plurality of drive arrays attached to said vehicle, each of said wheels having one of said drive arrays mechanically attached thereto, each of said drive arrays applying a rotational torque to an associated one of said wheels thereby facilitating each of said wheels to have an independent power source.

2. The assembly according to claim 1, wherein each of said drive arrays comprises a transmission being attached to said frame, each of said wheels having said transmission of one of said drive arrays being mechanically coupled thereto such that said transmission of each of said drive arrays discretely rotates the associated one of said wheels.

3. The assembly according to claim 2, further comprising an internal combustion engine being attached to said frame, said internal combustion engine being mechanically coupled to said transmission, said internal combustion engine driving said transmission when said internal combustion engine is actuated.

4. The assembly according to claim 1, further comprising:
a transmission; and
a motor, each of said wheels having said motor of one of said drive arrays positioned therein such that said motor of each of said drive arrays discretely rotates the associated one of said wheels, said motor being mechanically discrete from said transmission.

5. The assembly according to claim 4, further comprising a power supply, said power supply being attached to said frame, said power supply being electrically coupled to said motor, said power supply comprising at least one battery.

6. A vehicular drive assembly configured to provide multiple levels of redundancy, said assembly comprising:
a vehicle having a frame and a plurality of wheels rotatably coupled to said frame; and
a plurality of drive arrays attached to said vehicle, each of said wheels having one of said drive arrays mechanically attached thereto, each of said drive arrays applying a rotational torque to an associated one of said wheels thereby facilitating each of said wheels to have an independent power source, each of said drive arrays comprising
a transmission being attached to said frame, each of said wheels having said transmission of one of said drive arrays being mechanically coupled thereto such that said transmission of each of said drive arrays discretely rotates the associated one of said wheels,
an internal combustion engine being attached to said frame, said internal combustion engine being mechanically coupled to said transmission, said internal combustion engine driving said transmission when said internal combustion engine is actuated,
a motor attached to said vehicle, each of said wheels having said motor of one of said drive arrays positioned therein such that said motor of each of said drive arrays discretely rotates the associated one of said wheels, said motor being mechanically discrete from said transmission, and
a power supply, said power supply being attached to said frame, said power supply being electrically coupled to said motor, said power supply comprising at least one battery.
